(19) United States
(12) Patent Application Publication
(10) Pub. No.: US 2008/0320212 A1
(43) Pub. Date: Dec. 25, 2008

(54) CONTROL DEVICE AND CONTROL METHOD OF NONVOLATILE MEMORY AND STORAGE DEVICE

(75) Inventor: Tadaaki Kinoshita, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/143,241

(22) Filed: Jun. 20, 2008

(30) Foreign Application Priority Data
Jun. 22, 2007 (JP) 2007-165369

(51) Int. Cl. G06F 12/02; G06F 12/00; G06F 17/30

(52) U.S. Cl. 711/103; 707/205; 707/E17.01; 711/E12.008

(57) ABSTRACT

According to one embodiment, the control device according to an embodiment of the present invention, facilitates and speeds up averaging processing of the number of erases of a physical block (exchange processing of a physical block) of a nonvolatile memory. The device includes a file system control section that analyzes a file system of a nonvolatile memory and identifies a logical block of a read-only file, a logical/physical block address conversion table management section that obtains a first physical block corresponded to the logical block, and a physical block information management section that selects a second physical block that can be optionally used. Further, the device includes a physical block information modification section that moves data of the first physical block to the second physical block.

### CROSS-REFERENCE TO RELATED APPLICATIONS

This application is based upon and claims the benefit of priority from Japanese Patent Application No. 2007-165369, filed Jun. 22, 2007, the entire contents of which are incorporated herein by reference.

### BACKGROUND

1. Field

One embodiment of the present invention relates to a control device of a nonvolatile memory and a control method thereof, and a storage device.

In particular, the embodiment of the present invention is characterized in a nonvolatile memory management method that uses information of a file system to manage a logical block address/physical block address conversion table.

2. Description of the Related Art

A NAND-type flash memory is known as a data rewritable-nonvolatile memory. The data erase unit of the nonvolatile memory is one block (e.g., 128 kbytes). On the other hand, the data read and write unit of the nonvolatile memory is set to 2 kbytes. When the number of erases or writes is increased, device degradation occurs, resulting in increased occurrence of data errors. To cope with this, the number of writes is set to, e.g., about hundred thousand in order to guarantee device performance. Accordingly, a function of managing the number of physical block erases is incorporated in a memory controller of the nonvolatile memory (for example, Jpn. Pat. Appln. Publication No. 11-3287).

In addition, there is also proposed that an area of a file allocation table (FAT) having a higher number of rewrites is optionally changed to average the number of erases of a storage area (for example, Jpn. Pat. Appln. Publication No. 7-219720).

In a conventional nonvolatile memory management method, the number of erases is managed in physical blocks of the entire memory. Therefore, information processing for the number of erases is time-consuming.

### BRIEF DESCRIPTION OF THE SEVERAL VIEWS OF THE DRAWINGS

A general architecture that implements the various feature of the invention will now be described with reference to the drawings. The drawings and the relevant descriptions are provided to illustrate an embodiment of the invention and not to limit the scope of the invention.

FIG. 1 is a block diagram showing one embodiment of a storage device according to the present invention;

FIG. 2 is a view showing an example of a format of a file system;

FIG. 3 is a view that explains an example of an FAT in FIG. 2;

FIG. 4 is a view that explains an example of a file chain in FIG. 3;

FIG. 5 is a view showing an example of file information stored in a folder area in FIG. 2;

FIG. 6 shows an example of an area required at minimum in a storage area of a nonvolatile memory in FIG. 1;

FIG. 7 is a view showing an example of a logical/physical block address conversion table information section in FIG. 1;

FIG. 8 is a view showing an example of a physical block erase count information section in FIG. 1;

FIG. 9 is a view showing an example of a physical block use state information section in FIG. 1;

FIG. 10 is a flowchart that explains an operation to obtain a logical block address, in which data of a file that is determined to be used mainly for the purpose of read based on an attribute or an identifier of a read-only file, is stored;

FIG. 11 is a flowchart that explains an example of a basic operation of the present invention;

FIG. 12 is a flowchart that explains an operation example of a storage device at the time of processing a write command from a host;

FIG. 13 is a view that explains an example of a time series of information sent from a host; and

FIG. 14 is a view that explains an example of a tree structure of a folder.

### DETAILED DESCRIPTION

An embodiment according to the invention will be described hereinafter with reference to the accompanying drawings.

An object of one embodiment according to the present invention is to provide a control device and a control method of a nonvolatile memory and a storage device that can facilitate and speed up averaging processing (exchange processing of physical blocks) of the number of physical block erases of a nonvolatile memory.

In order to achieve the above object, the present invention includes a means for identifying a logical block address which stores data of a file that is determined to be mainly used for the purpose of read based on an attribute and an identifier of a read-only file by analyzing a file system, and obtaining a physical block that is associated with the logical block by a logical/physical block address conversion table, a means for selecting a proper physical block from a group of physical blocks that can be optionally used based on erase count information of each physical block, and a means for switching roles (an “in use” state where effective data is stored in a physical block and a “ready” state where a physical block can be optionally used) between physical blocks required by the above means.

Specifically, the present invention includes a file system control section that analyzes a file system of a nonvolatile memory device and identifies a logical block of a read-only file that is determined to be used for the purpose of read, a logical/physical block address conversion table management section that uses the logical/physical block address conversion table and obtains a first physical block from a physical block address associated with the logical block, a physical block information management section that references physical block use state information and physical block erase count information and selects a second physical block that satisfies a predetermined condition from a group of physical blocks that can be optionally used, and a physical block information modification section that moves data of the first physical block to the second physical block, associates an address of the second physical block with the logical block address, and modifies a use state of the first and the second physical blocks in the physical block use state information.

According to the above means, a group of physical blocks to be exchanged can be grasped at once by using information of a file system, which is suitable for high speed processing.

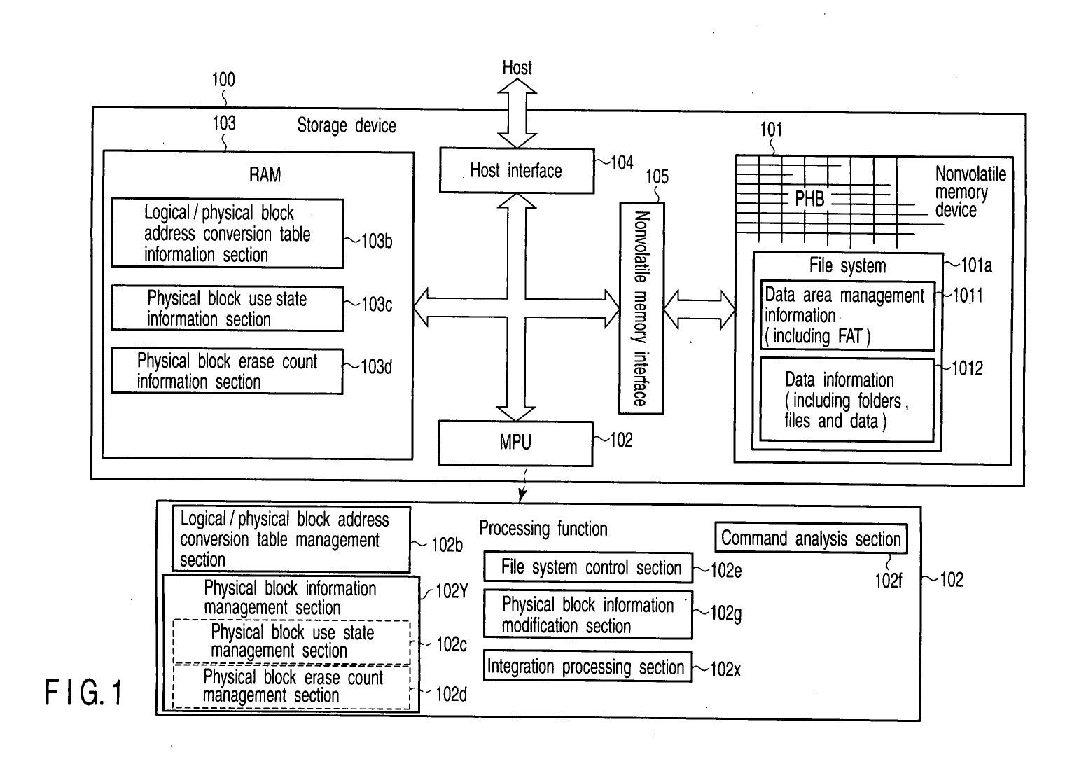

Hereinafter, with reference to the accompanying drawings, an embodiment of the present invention will be described. First, a description is given of a configuration of a storage device to which the present invention is applied and is shown in FIG. 1.

<Storage Device>

A storage device 100 has a nonvolatile memory device 101, a micro processing unit (MPU) 102, a random access memory (RAM) unit 103, a host interface 104, and a nonvolatile memory interface 105.

A storage area of the nonvolatile memory device 101 is configured with a number of physical blocks PHBs, and includes a file system 101a at a section of the storage area.

The file system 101a includes data area management information 1011 and a data area 1012. The data area management information 1011 includes a file allocation table (FAT). In addition, the data area 1012 includes a folder, file data, and so on.

As a storage section set in the RAM 103, there are information sections as follows. There is a logical/physical block address conversion table information section 103b having a table that has associated a logical block address with a physical block address. Further, there is a physical block information management section 102Y. This physical block information management section 102Y has a physical block use state information section 103c storing a use state of physical blocks and a physical block erase count information section 103d. Although not shown, an area that develops a program to be executed by the MPU 102 is also secured.

The logical block address described above is a logical block address of logical address space that is used by a host device. In addition, the physical block address is a physical block address in the nonvolatile memory device 101.

In addition, the physical block use state information section 103c registers a block address of a physical block that can be optionally used. Here, an address of a physical block for which a logical block address and a physical block address are not associated is registered. Alternatively, addresses of all physical blocks are described, and an identifier showing whether a physical block is associated with a logical block or not is added.

The physical block erase count information section 103d stores the number of physical block erases that can be optionally used and registered in the physical block address use state information section 103c.

Although it was described that the physical block use state information section 103c and the physical block erase count information section 103d have a block address of a physical block that can be optionally used, the section 103c and the section 103d may have block addresses of all physical blocks.

The physical block use state information, the logical/physical block address conversion table, a physical block address, and information such as a physical block erase count in the RAM 103 are managed and processed by a function of the MPU 102.

Therefore, the MPU 102 has the logical/physical block address conversion table management section 102b, the physical block use state management section 102c that stores a use state of a physical block, and a physical block erase count management section 102d. In addition, the MPU 102 has a file system control section 102e that controls a file system in the nonvolatile memory device 101, and further, a physical block information modification section 102g that is a feature of the device. This physical block information modification section 102g may be included in the file system control section 102e. However, the section 102g is shown here for the sake of description. As described later, data of the first physical block may be moved to the second physical block, and an address of the second physical block may be associated with a logical block address. In addition, use states of the first and the second physical blocks in the physical block use state information may be modified. Further, the physical block information modification section 102g can erase data of the first physical block when modifying a use state of the first physical block in the physical block use state information section.

In addition, the MPU 102 has an integration processing section 102x that controls the management sections described above. The integrated processing section 102x also executes write and readout of data.

A file system control section 102e can analyze a file system, and also carry out update processing of a file system. When a file system is analyzed, file information of each file in a folder is checked. File information includes attribute information showing whether a file is a read-only file or not. Alternatively, there is a case where whether a file is a read-only file or not can be determined by an identifier. Next, a logical block address in which data of a file that is determined to be used for the purpose of read can be identified by using a FAT.

The logical/physical block address conversion table management section 102b controls the logical/physical block address conversion table. In this manner, a physical block that is associated with a logical block is grasped (this physical block will be referred to as “current physical block” or “first physical block”).

In addition, the physical block information management section 102Y is referenced. For example, the physical block use state information section 103c is accessed, and an appropriate physical block is selected from a group of physical blocks that can be optionally used based on erase count information of each physical block (this physical block will be referred to as “selected physical block” or “second physical block”). Further, an address of the current physical block in use and an address of the selected physical block are exchanged in the logical/physical block address conversion table. This processing is mainly executed by the physical block information modification section 102g.

Further, data of the current physical block in use is moved to the selected physical block. Then, the data in the current physical block is erased, and an erase count thereof is updated. Then, the current physical block is registered in the physical block use state information section 103c as a physical block that can optionally be used under control of the physical block use state management section 102c. That is, a state of the above current physical block is changed from the “in-use” state where effective data is stored in the physical block to the “ready” state where the physical block can be optionally used.

<Basic Configuration of File System>

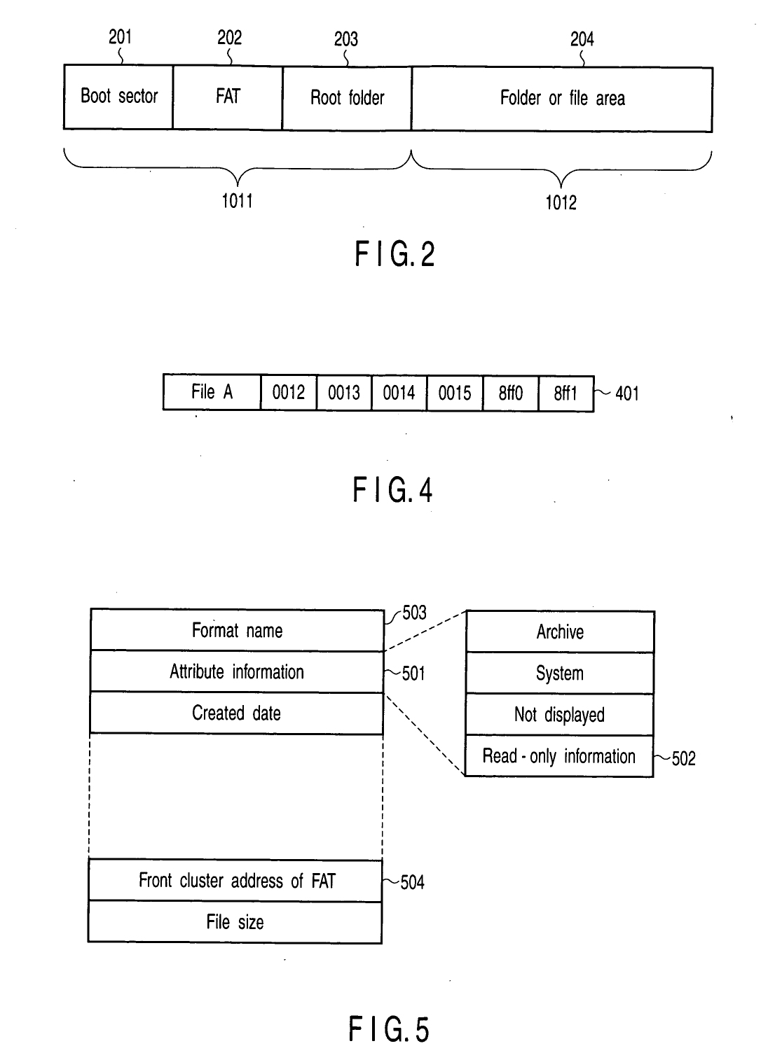

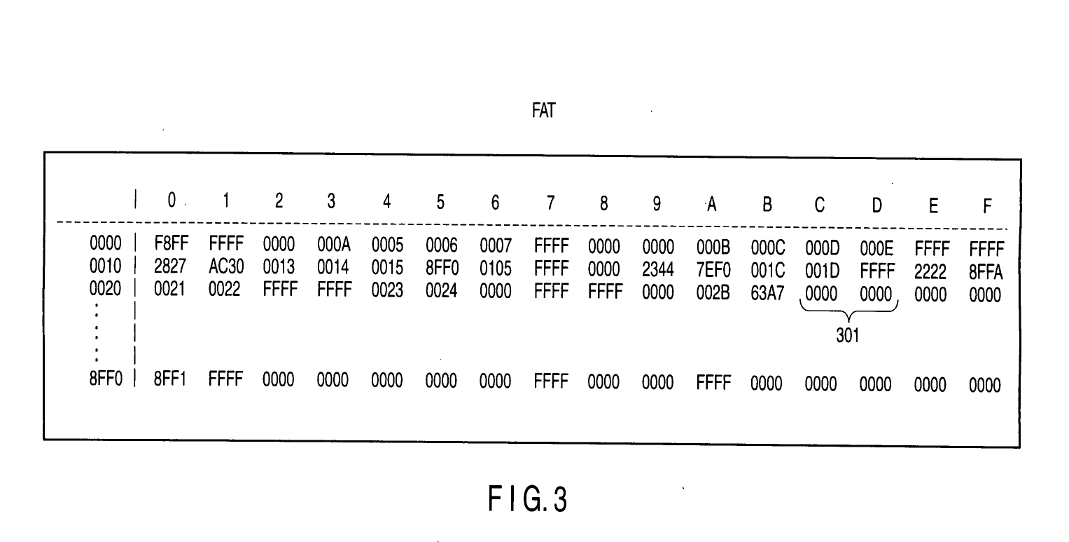

FIG. 2 is a view showing a configuration example of a file system. The data area management information 1011 stores information other than data of the file. That is, the information 1011 includes a boot sector 201, an FAT 202, and a root folder 203. In addition, the data area 1012 includes a folder and/or file 204.

<FAT and Cluster Chain of File; FIGS. 3 and 4>

FIG. 3 shows an example of the FAT. FIG. 4 shows an example of a chain table of a file configured with six clusters.

The FAT is a table that shows a configuration of each file in a data unit called a cluster allocated to the data area 1012 as shown in FIG. 3.

It is assumed here that a given file A is configured with six clusters as shown by a numerical number 401 in FIG. 4. FAT data operates a cluster chain showing a plurality of cluster addresses configuring the file so that the cluster addresses are sequentially referred to, starting from the first cluster address configuring the file A.

Since the last cluster of the file has no chain, it shows FFFFh. Some table data represent special clusters. 0000h is an unused cluster. F8FFh is reservation system data.

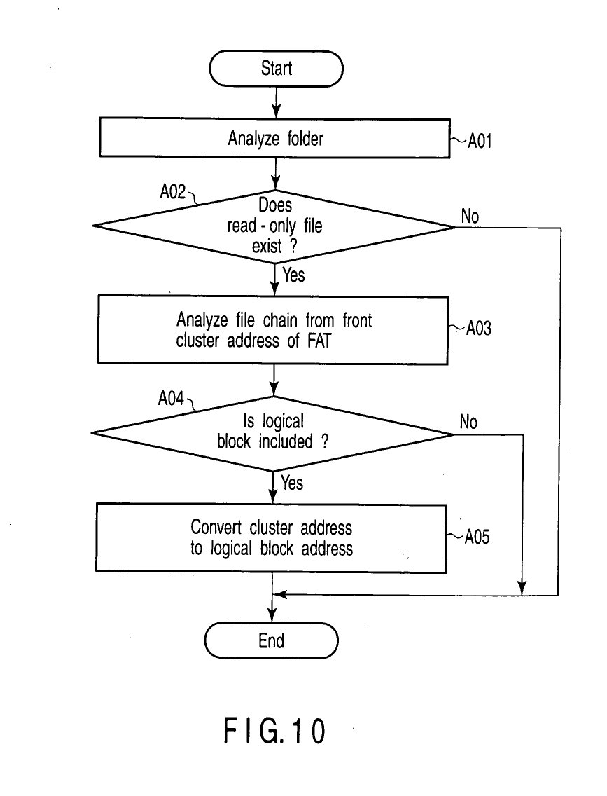

On the assumption that two clusters are equivalent to one physical block (=one logical block), when a file shown in FIG. 4 is determined to be a read-only file, a physical block associated with a logical block indicated by a numerical number 301 may be a target for processing in FIG. 10 which will be described later.

<File Information in Folder>

A folder stores one or more files (an example is shown in FIG. 4). FIG. 5 is a view showing file information existing in each file in the folder. The file information includes format name information 503 in which information of a file name including an identifier is written, and file attribute information 501. The file attribute information 501 includes read-only information 502. In addition, the file information includes front information (front cluster address) 504 of a file chain of the FAT.

Therefore, when a content of the read-only information 502 of file identification information is determined, whether the file is a read-only file or not can be determined.

<Storage Area 601 in Nonvolatile Memory Device>

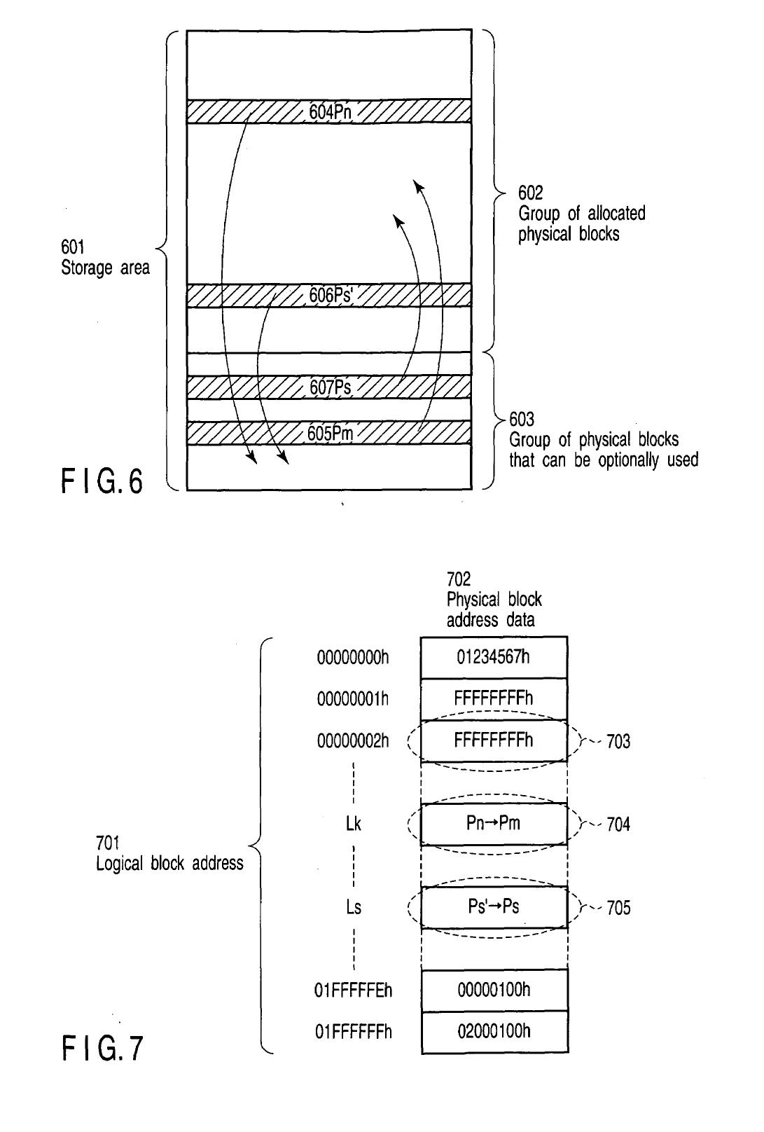

FIG. 6 shows an example of a storage area in the nonvolatile memory device. A storage area 601 on the nonvolatile memory device 101 is all configured with physical blocks, and is associated with a logical block in a logical/physical block address conversion table information section 107. In addition, this group of physical blocks may be classified into allocated physical blocks 602 and physical blocks 603 that can be optionally used.

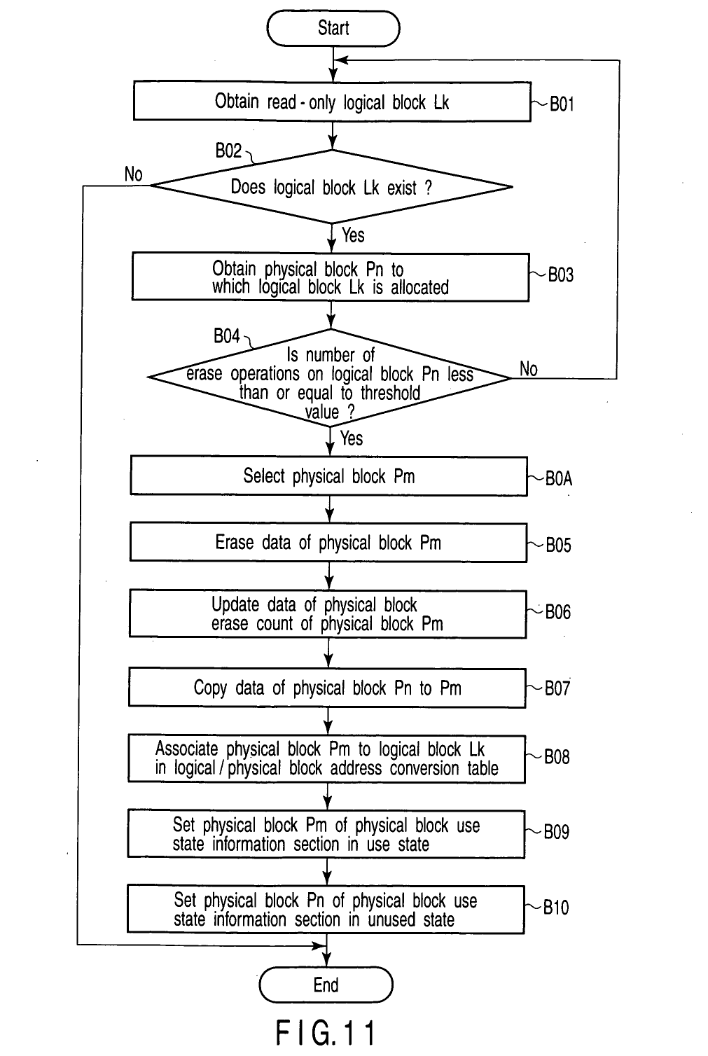

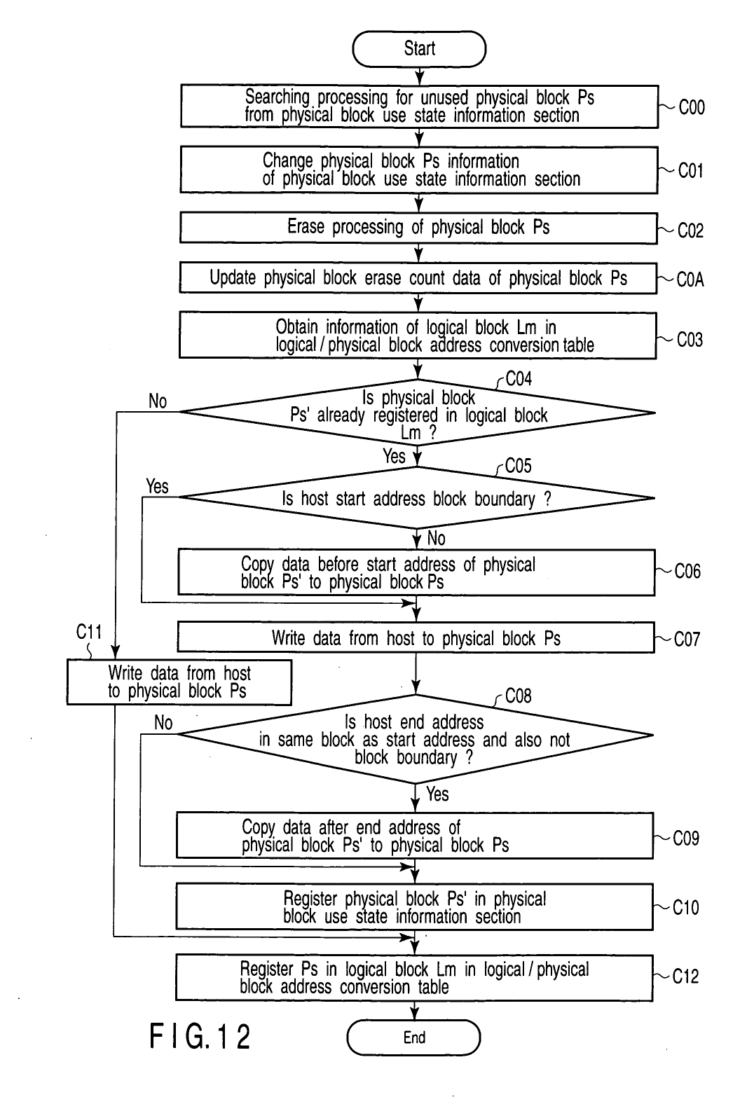

As described later, a physical block Pn described in FIG. 11 and Ps′ described in FIG. 12 change to the physical block 603 that can be optionally used, and a physical block Pm described in FIG. 11 and Ps described in FIG. 12 change to the allocated physical block 602 that is associated with a logical block in the logical/physical block address conversion table information section 107.

(Logical/Physical Block Address Conversion Table)

FIG. 7 is a view showing an example of the logical/physical block address conversion table information section 107 in FIG. 1. A logical block address 701 is equivalent to an offset address in a four-byte unit starting from an optional address on the RAM 103, and a data section stores physical block address data 702 associated with the logical block address 301. A data section of a logical block address with which a physical block is not associated stores FFFFFFFFh data (703).

In step B00 in FIG. 11 described later, address data change processing indicated by a numerical number 704 is carried out, and in step C12 in FIG. 12, address data change processing indicated by a numerical number 705 is carried out.

<Physical Block Erase Count Information>

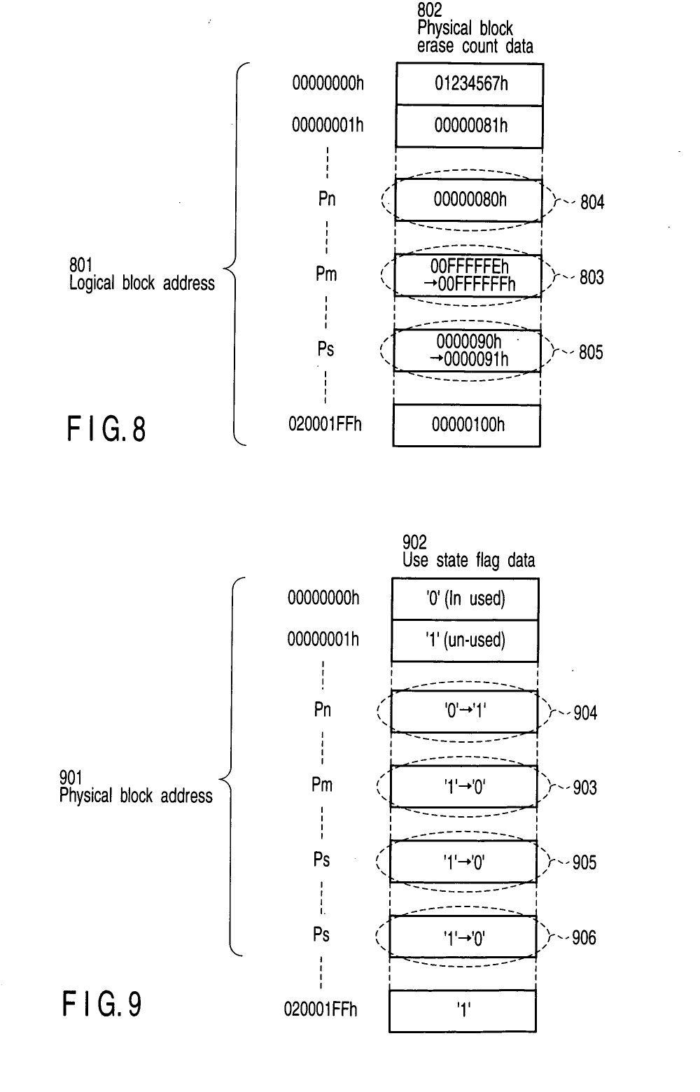

FIG. 8 is a view that explains an example of the physical block erase count information section 103d in FIG. 1. A physical block address 801 is equivalent to a four-byte unit of an offset address starting from an optional address on the RAM 103, and a data section stores erase count data 802 for each physical block address. Data erase processing is carried out; however, at this time in step B05 in FIG. 11 described later, data erase processing is carried out as indicated by a numerical number 803. In addition, update processing of erase count data is carried out in step C0A in FIG. 12 described later; however, at this time, update processing of erase count data is carried out as indicated by a numerical number 805. Further, an erase count of the physical address Pn in FIG. 11 described later is processed as indicated by a numerical number 804.

<Physical Block Use State Information>

FIG. 9 is a view showing an example of the physical block use state information section 103c in FIG. 1. A physical block address 901 is equivalent to an offset address of a one-bit unit starting from an optional address on the RAM 103, and a data section is configured with flag data 902 of one bit showing whether the address 901 can be optionally used. A data section referenced by a physical block address that can be optionally used stores “1”, and a data section that is referenced by a physical block address that is already used stores “0”. A physical block is set in a use state in step B09 in FIG. 11 described later; however, at this time, flag processing indicated by a numerical number 903 is carried out. On the contrary, a physical block is set in an unused state in step B10 in FIG. 11; however, at this time, flag processing indicated by a numerical number 904 is carried out. Flag processing indicated by a numerical number 905 is carried out in step C01 in FIG. 12 described later, and flag processing indicated by a numerical number 906 is carried out in step C10.

<Retrieval of Read-Only Logical Block>

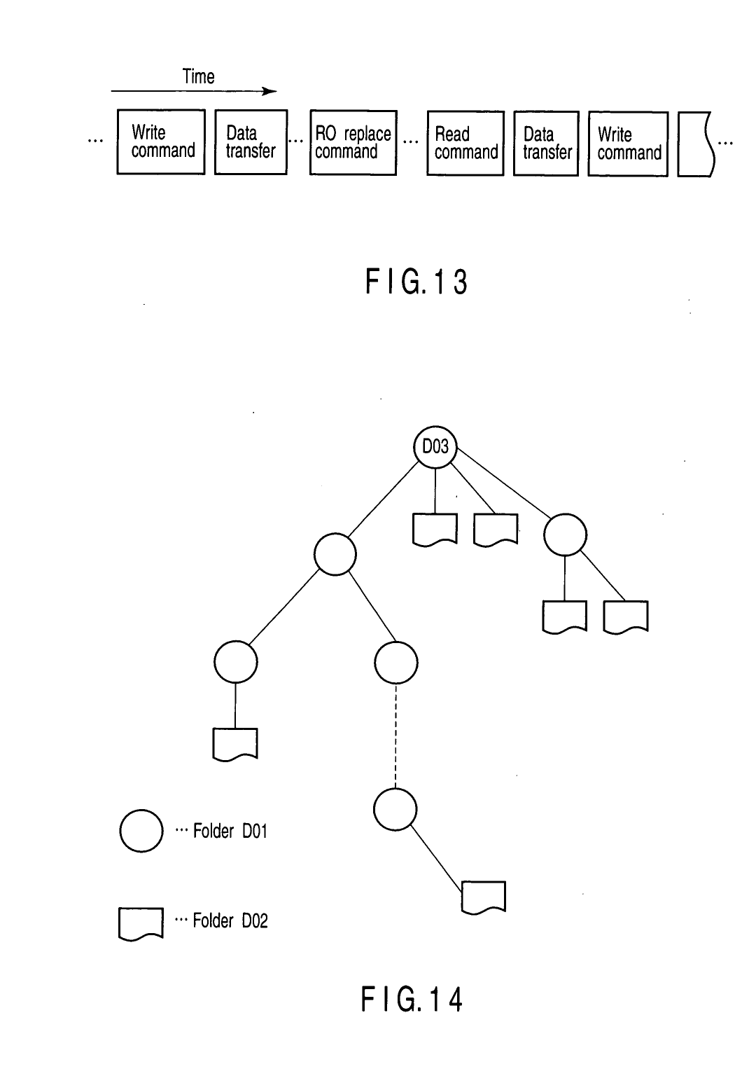

FIG. 10 is a flowchart that explains an operation of B01 in FIG. 11. An operation performing timing in FIG. 10, that is, FIG. 11, is optional and is not specified. However, it is preferable that the operation is performed at an interval between commands from a host shown in FIG. 13 or between each time of execution of a program operating on the MPU 12.

In addition, in the present embodiment, it is not specified that, from which folder, from which file, and from where in a cluster chain, folder analysis of a file structure as shown in FIG. 14 should be started.

If there exist one or more files in a folder, there is stored file information (FIG. 5) of one or more files in the folder, and whether a file is a read-only file or not is analyzed from the file information (step A01). If there does not exist any read-only file, the analysis is terminated, and another folder is analyzed as needed. If there exists a read-only file, the operation goes along a cluster chain as shown in FIG. 4 from the front cluster address 504 (shown in FIG. 5) of the file (step A03). Then, a location where a logical block as indicated by the numerical number 301 in FIG. 3 is included is discriminated (step A04), and a cluster address is converted to a logical block address (step A05). In this manner, a logical block address in the read-only file is discriminated.

<Basic Operation>

FIG. 11 is a flowchart that explains a basic operation of the present invention. A section of a program stored in the RAM 103 can obtain a logical block Lk of a read-only file by analyzing a file system 106 (step B01).

If the logical block Lk does not exist, the operation is terminated (step B02). If the logical block Lk exists, the physical block Pn to which the logical block Lk is allocated is obtained by referencing the logical/physical block address conversion table information section (step B03).

Next, with respect to the physical block Pn, whether a value of an erase count of the physical block Pn is larger than an optional threshold value or not is determined by referring physical block erase count information. If the value of the erase count of the physical block Pn is greater than the optional threshold value, physical block exchange processing with respect to the logical block Lk is not carried out, and if the value is less than or equal to the optional threshold value, the following processing is carried out (step B04).

The optional physical block Pm is selected from physical blocks that can be optionally used and has a physical block erase count equal to or greater than the threshold value (step BOA), and data of the physical block Pm is erased (step B05). Next, physical block erase count data of the physical block Pm is updated (step B06), and data of the physical block Pn is copied to the physical block Pm (step B07).

Next, physical block information associated with the logical block Lk of the logical/physical block address conversion table information section is updated from Pn to Pm (step B08), and a flag of the physical block Pm of the physical block use state information section is changed to a use state (step B09). Further, information of the physical block Pn of the physical block use state information section is changed to an unused state (step B10). From the above operation, the logical block Lk is associated with a physical block having a lower write count tolerance.

<Description of Operation Example in Response to Command from Host)

FIG. 12 is a flowchart that explains an operation example at the time when a device of the present invention receives a write command from a host and carries out data processing.

Here, it is assumed that the MPU 102 receives a write command from a host via the host interface 104. The MPU 102 retrieves an unused physical block Ps from the physical block use state information section 103c (step C00), changes physical block Ps use information of the physical block use information section 103c (step C0), carries out data erase processing of the physical block Ps (step C02), and updates physical block erase count data of the physical block Ps (step C0A).

Next, information with respect to the logical block Lm in which a host should write data is obtained on a table of the logical/physical block address conversion table information section 103b (step C03). In other words, it is determined whether a physical block associated with the logical block Lm exists or not. Here, if the physical block Ps′ is not already registered for the logical block Lm, the data from the host is written in the physical block Ps (step C11). However, if the physical block Ps′ is already registered (if the physical block Ps′ has already existed), the operation proceeds to step C05 (step C04).

Whether a host start address designated by the host is a boundary of a physical block or not is determined (step C05). This is because a write start address is not always a forefront of a physical block.

If the host start address is not a block boundary, data in the physical block Ps′ and is before the start address is first copied to the physical block Ps (step C06). In this manner, loss of data is prevented. If the host start address is a block boundary, the above step is skipped, and the data from the host is written in the physical block Ps (step C07).

Whether a host end address designated by the host is the same address as the start address and is not a block boundary is determined (step C08). If the host end address is a block boundary, data in the physical block Ps′ and after the end address is copied to the physical block Ps (step C09).

The physical block Ps′ is registered in the physical block use state information section 103c as a physical block that can be optionally used at this time (step C10). In addition, PS is associated with the logical block Lm on the logical/physical block address conversion table and is registered (step C12). If a target for a write access from the host exceeds one block, the operation from step C00 is further repeated.

<Command from Host>

FIG. 13 is a view that explains an example shown in a time series of information sent from a host with respect to a device of the present invention. Periods of information sent from a host to the storage device 100 include a write command period, a data transfer period, a read command period, a data transfer period. Among these, a processing period (1301) of a read-only file may be set. An RO command to be sent to the processing period 1301 of a read-only file is newly established, the MPU 102 responds to the RO command, and the operation shown in FIGS. 10 and 11 is obtained.

<Example of Folder>

FIG. 14 is a view that explains an example of a tree structure of a folder. A root folder D03 is located at the top, and a folder tree is configured with the root folder D03 located at the top, and a file D02 belongs to the folders (D01 and D03).

As described above, the present embodiment retrieves a logical block for read-only purposes in a systematic manner by analyzing file system information, and processes a physical block that is associated with the logical block in the logical/physical block address conversion table. For this reason, selecting of a physical block having low possibility of a write access is possible without providing a monitor information section (requires a wide memory area since the number of tables for monitoring increases as capacity increases) in a physical block unit that is conventionally required.

The present embodiment stores data that has low possibility of a write access in a physical block that is close to the limit of the number of uses in a nonvolatile memory having a limit on the number of erases and writes in a block unit, and can secure a physical block that is far from the limit of the number of uses in a state in which the physical block can be optionally used, that is, for the purpose of data write. In this manner, the limit of the number of rewrites as an entire storage device can be improved.

As described above, the present device allocates a physical block having a short rewrite life to a logical address with a low rewrite probability, and a physical block having a long rewrite life to a logical address or a physical block that can optionally be used having a high rewrite probability. In this manner, the limit of the number of rewrites as an entire storage device can be improved.

In addition, by erasing data in advance when allocation to a physical block that can optionally be used is carried out, time for erase of a physical block for each data write from a host and redundant data write time generated along data write from a host can be reduced, and speed of write processing from a host can be increased.

The present invention is not limited to the embodiment described above, and may be embodied by modifying components in a range not departing from the spirit thereof at an implementation stage. In addition, a variety of inventions can be formed by a proper combination of a plurality of the components described in the above embodiment. For example, some of the components may be eliminated from all of the components shown in the embodiment.

While certain embodiment of the inventions has been described, this embodiment has been presented by way of example only, and is not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A control device of a nonvolatile memory, comprising:
a file system control section that analyzes a file system of a nonvolatile memory device and identifies a logical block of a read-only file that is determined to be used for read purposes;
a logical/physical block address conversion table management section that uses a logical/physical block address conversion table and obtains a first physical block from a physical block address associated with the logical block;
a physical block information management section that references physical block use state information and physical block erase count information, and selects a second physical block that satisfies a predetermined condition from a group of physical blocks that can be optionally used; and
a physical block information modification section that moves data of the first physical block to the second physical block, associates an address of the second physical block to the logical block address, and modifies a use state of the first and the second physical blocks in the physical block use state information.

2. The control device of a nonvolatile memory according to claim 1, wherein
the physical block information modification section erases data of the first physical block when a use state of the first physical block in the physical block use state information section is modified.

3. The control device of a nonvolatile memory according to claim 1, wherein
the file system control section starts identifying a logical block in which data of the read-only file is stored when a predetermined command is sent from a host.

4. The control device of a nonvolatile memory according to claim 1, wherein
the file system control section recognizes the read-only file from attribute information of each file included in the file system of the nonvolatile memory, and recognizes a logical address of the read-only file from a file allocation table.

5. A control method of a nonvolatile memory for controlling a nonvolatile memory device having a limit on the number of erases in a physical block unit and/or a programming frequency by a random access memory and a control section, wherein
the control method comprising:
analyzing a file system of the nonvolatile memory device and identifies a logical block of a read-only file that is determined to be used for read purposes,
using a logical/physical block address conversion table and obtains a first physical block from a physical block address associated with the logical block,
referencing physical block use state information and physical block erase count information and selects a second physical block that satisfies a predetermined condition from a group of physical blocks that can be optionally used, and
moving data of the first physical block to the second physical block, associates an address of the second physical block to the logical block address, and modifies a use state of the first and the second physical blocks in the physical block use state information.

6. The control method of a nonvolatile memory according to claim 5, further comprising,
erasing data of the first physical block when a use state of the first physical block is modified.

7. The control method of a nonvolatile memory according to claim 5, wherein
the control section starts identification processing of a logical block in which data of the read-only file is stored when a predetermined command is sent from a host.

8. The control method of a nonvolatile memory according to claim 5, wherein
the control section recognizes the read-only file from attribute information of each file included in the file system of the nonvolatile memory, and recognizes a logical address of the read-only file from a file allocation table.

9. A storage device having a host interface that receives data including a command from a host, a random access memory, a nonvolatile memory device, and a micro processing unit that analyzes the command and perform overall of control the random access memory and the nonvolatile memory device, comprising:
a file system control section that analyzes a file system of the nonvolatile memory device and identifies a logical block of data of a read-only file that is determined to be used for read purposes;
a logical/physical block address conversion table management section that uses a logical/physical block address conversion table and obtains a first physical block from a physical block address associated with the logical block;
a physical block information management section that references physical block use state information and physical block erase count information and selects a second physical block that satisfies a predetermined condition from a group of physical blocks that can be optionally used; and
a physical block information modification section that moves data of the first physical block to the second physical block, associates an address of the second physical block to the logical block address, and modifies a use state of the first and the second physical blocks in the physical block use state information.

10. The storage device according to claim 9, wherein
the physical block information modification section erases data of the first physical block when a use state of the first physical block in the physical block use state information section is modified.

11. The storage device according to claim 9, wherein
the file system control section starts identifying a logical block in which data of the read-only file is stored when a predetermined command is sent from a host.
